(19) United States
(12) Patent Application Publication
(10) Pub. No.: US 2009/0299004 A1
(43) Pub. Date: Dec. 3, 2009

(54) Pressure Sensitive Adhesives

(76) Inventors: Leo Ternorutsky, East Longmeadow, MA (US); Jong-Shing Guo, Longmeadow, MA (US); Augustin Chen, Cheschire, MA (US)

Correspondence Address: WENDEROTH, LIND & PONACK, L.L.P., 1030 15th Street, N.W.,, Suite 400 East, Washington, DC, 20005-1503, US

(21) Appl. No.: 12/227,143

(22) PCT Filed: Jun. 1, 2007
(86) PCT No.: PCT/EP2007/055397

§ 371 Date: Mar. 24, 2009

Related U.S. Application Data
(60) Provisional application No. 60/809,847, filed on Jun. 1, 2006.

(51) Int. Cl. C09J 11/00

(52) U.S. Cl. 524/743; 106/316

(57) ABSTRACT

PSAs having high shear stability are disclosed. The PSAs are obtained from an aqueous dispersion comprising an effective amount of surfactant mixture comprising at least one ionic surfactant comprising a plurality, preferably at least three, aromatic rings, at least one electronegative substituent selected from a mono valent oxy substituted sulfo anion, and/or a mono valent oxy substituted phospho anion, and optionally at least one substituent comprising one or more repeating alkoxy units (e.g. Soprophor 4D 384 and/or DPOS-45), and at least one non-ionic surfactant (e.g. Abex 2535) and a monomer composition comprising: at least one hydrophobic monomer (Component I), at least one hydrophilic monomer (Component II) at least one partially hydrophilic monomer (Component III). The dispersion forms PSAs which are sufficiently stable under high shear to be curtain coatable.

This invention relates to pressure sensitive adhesives (PSA) based on aqueous emulsions and processes for preparation of the adhesives. The pressure sensitive adhesives of the invention have resistance to high shear and therefore are coatable with high speed machines.

High speed coating machines are used to apply commercial PSAs at high volumes generate high shear fields. For example typical equipment such as Moyno pumps, slot dies, pressurized gravure and curtain coaters generate shear fields of typically over 150,000s⁻¹ in the coating head and/or in the progressive cavity pump. If conventional PSA emulsions are used in these machines the emulsion de-stabilises under the high shear field to form coagulum. The coagulum blocks the die, causes scratch lines on the coating web and builds up high pressure in the die and pump. Excess coagulum must therefore be removed and this requires the coater to be temporarily shut down which is undesirable as it increases cost.

This limits the commercial use of PSAs as most PSAs are not readily stable under high shear, especially at high speeds required for techniques such as curtain coating. There is a need for a curtain coatable PSA of improved stability.

It is therefore an object of the present invention to solve some or all of the problems with the prior art PSA emulsions. The present invention relates to a composition of and process for making a waterborne adhesive which has improved stability under a high shear field.

Therefore broadly in accordance with the present invention there is provided an aqueous dispersion suitable for preparing pressure sensitive adhesive (PSA) having acceptable, optionally enhanced, stability under high shear, where the dispersion comprises:
(a) an effective amount of surfactant mixture comprising
   (i) at least one ionic surfactant comprising
      (I) a plurality, preferably at least three, aromatic rings,
   (II) at least one electronegative substituent formed from a strong acid, optionally selected from a mono valent oxy substituted sulfo anion, and/or a mono valent oxy substituted phospho anion, and
      (III) optionally at least one substituent comprising multiple hetero-organo units, optionally one or more repeating oxyhydrocarbylene units which may be the same or different,
   (ii) optionally at least one non-ionic surfactant optionally non aromatic which preferably comprises at least one at least one substituent comprising multiple hetero-organo units, optionally one or more repeating oxyhydrocarbylene units which may be the same or different, and
   (iii) optionally a further ionic surfactant which may be as defined in (a) (i)
(b) a monomer composition comprising:
   (i) at least one hydrophobic monomer (Component I),
   (ii) at least one hydrophilic monomer (Component II)
   (iii) at least one partially hydrophilic monomer (Component III)

It is preferred that the adhesive latex of the invention forms substantially no coagulum when the latex is subject to a shear field of at least 4000 s⁻¹ for at least 2 minutes.

Preferred dispersions of the invention are substantially free of any surfactant which will polymerise under the conditions of polymerisation of the monomer composition.

Optionally the dispersion has an average particle size of from about 100 nm to about 400 nm.

As used herein the term strong acid preferably indicates an acid that has a pKₐ (under the conditions of the process of the invention) of less than about 3, more preferably less than about 2.

Adhesive emulsions of the invention can be applied by a wide variety of high speed methods including curtain coating.

### High Shear Stability

As used herein high shear means a shear rate of at least 4000 s⁻¹, preferably at least 20,000 s⁻¹, more preferably at least 70,000 s⁻¹, for example at least 150,000 s⁻¹.

Conveniently as used herein acceptable high shear stable means substantially no coagulum forms (i.e. the emulsion or dispersion does not de-stabilise) when subject to a shear field of at least 4000 s⁻¹ for at least 2 minutes, more conveniently good high shear stability means stable at least 20,000 s⁻¹ for at least 5 minutes, most conveniently enhanced high shear stability means stable at least 70,000 s⁻¹ for at least 10 minutes, for example optimum high shear stability means stable at least 150,000 s⁻¹ for at least 10 minutes.

### Surfactants

Optionally at least one of the aromatic ionic surfactant (a) (i) and/or (a) (iii) has a HLB value from about 8 to about 20, preferably from about 10 to about 18, more preferably from about 12 to about 17, for example about 16.

Conveniently at least one of the aromatic ionic surfactants is represented by Formula 1

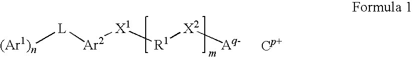

where Ar¹ and Ar² independently in each case each represent C₆₋₁₈ hydrocarbo comprising an aromatic moiety,
L is a divalent organo linking group or direct bond, where optionally Ar¹ and Ar² may together form a fused ring;
R¹ is an optionally substituted C₁₋₈ hydrocarbylene, more preferably C₁₋₆ alkylene;
X¹ and X² independently in each case each represent O, S, CH₂, NH or NR³ where R³ represents optionally substituted C₁₋₂₀ hydrocarbyl, more preferably C₁₋₁₀ alkyl;
A represents a S(O)₁₋₃ or P(O)₁₋₃ moiety and q is from 1 to 3;
C is a suitable counter cation and p balances the charge q;
m represents an integer from 1 to 70, preferably from 5 to 60; more preferably from 10 to 50; most preferably from 10 to 30 for example about 16;
n represents an integer 1 to 6, optionally 1 to 3.

More conveniently the at least one ionic surfactant of Formula 1 is represented by Formula 1a

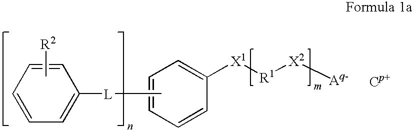

where L, R¹, X¹, X², A, C, q, p, n and m are as given for Formula 1, and R² is an optionally substituted C₁₋₈ hydrocarbylene, more preferably C₁₋₆ alkylene.

More preferably in Formula 1a
L, R¹ and R² are independently in each case C₁₋₄ alkylene, more preferably —CHCH₂(CH₃)—, —CH(CH₃)— or —CH₂CH₂—,
X¹ and X² independently in each case O, S, NH or —N(C₁₋₆ alkyl)—, most preferably O,
A is a S(O)₃ or P(O)₃ and q is 1
C is a suitable counter cation and optionally p is 1;
n is from 1 to 3 more preferably 3, and m is from 10 to 30, most preferably 10 to 20.

Most preferred surfactants of Formulae 1 and 1a are those that are obtained and/or obtainable by the reaction of styrene and phenol and subsequent phosphation and/or sulfation of the resultant alkoxylated multiply styryl substituted phenol (such as tristryryl phenol and/or derivatives thereof).

Particularly preferred tristryryl phenol ionic surfactants of Formulae 1 and 1a are those available from Rhodia under the following trade designations:
Soprophor 3D-33 (an ethoxylated phosphate ester free acid);
Soprophor 3D-33/LN (a low non ionic ethoxylated phosphate ester free acid);
Soprophor 3D-FLK (an ethoxylated phosphate ester potassium salt);
Soprophor 3D-FL (an ethoxylated phosphate TEA (triethylamine) salt);
Soprophor 3D-FL-60 (an ethoxylated phosphate TEA (triethylamine) salt);
Soprophor 4D-384 (an ethoxylated sulfate, ammonium salt);
Soprophor 4D-360 (an ethoxylated sulfate, ammonium salt); and/or any suitable mixtures thereof.

An exemplified surfactant may be represented by

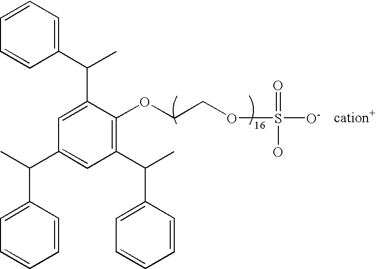

which (when the cation is ammonium) is available from Rhodia under the trade designation Soprophor 4D384.

In an alternative embodiment optionally substituted derivatives of alkylene naphthyl sulfonate available commercially from King Industries may be used as the ionic, surfactant.

Conveniently the further aromatic ionic surfactant (a) (iii) may be represented by Formula 2

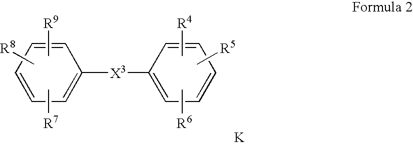

in which
X³ represents O, S, CH₂, NH or NR¹⁰ where R¹⁰ represents optionally substituted C₁₋₂₀ hydrocarbyl, more preferably C₁₋₁₀ alkyl,
from 1 to 4 (preferably 1 to 2) of the radicals R⁴ to R⁹ are at least one electronegative substituent formed from a hard acid, preferably selected from a mono valent oxy substituted sulfo anion, and/or a mono valent oxy substituted phospho anion, more preferably —S(O)₁₋₃^{Q-} or P(O)₁₋₃^{Q-} moiety where Q is from 1 to 3;
and the remainder of R⁴ to R⁹ are independently H or C₁₋₃₀ hydrocarbyl, preferably H or C₁₋₂₀ alkylene; and
K^{P+} is a counter cation where ‘P’ is ‘Q’.

Particularly preferred ionic surfactants of Formula 2 are disodium mono- & didodecyl diphenyl oxide disulfonates such as

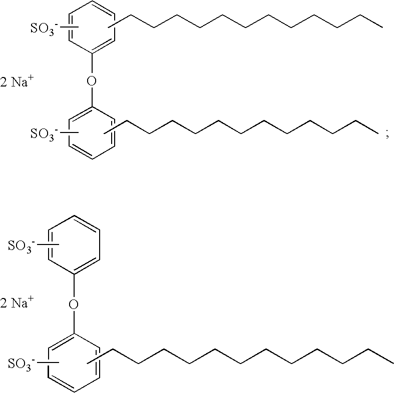

and/or mixtures thereof such as the mixture available from Cytec under the trade designation DPOS-45.

A alternative optional further ionic surfactant(s) comprises those of the following formula

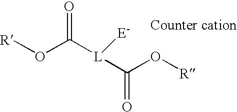

where E is the electronegative group, preferably SO₃ or PO₂,
L is a tirvalent organo linking group, preferably C₁₋₄ alkylene; and
R′ and R″ are independently each H or optionally substituted C₁₋₃₀ hydrocarbyl

More preferred optional other ionic surfactants are represented by

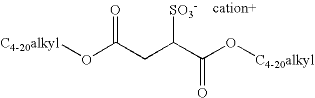

An example of such an optional other ionic surfactant is sodium dioctyl sulfosuccinate which is available commercially from Cytec under the trade name Aerosol OT.

Surfactants of Formulae 1 and/or 1a are preferred to those of Formulae 2 and/or 2a and usefully the surfactant mixture comprises at least one surfactant of Formulae 1 and/or 1a.

The optionally non-ionic surfactant (a) (ii) may be any suitable such as an aliphatic non ionic surfactant of Formula 3

R¹¹—X⁴—(Z—X⁵)_{w}H Formula 3

where
R¹¹ represents optionally substituted C₁₋₅₀ hydrocarbyl, more preferably C₁₋₃₀ alkyl; more preferably C₁₋₂₀ alkyl;
X⁴ and X⁵ independently in each case each represent O, S, CH₂, NH or NR¹² where R¹² represents optionally substituted C₁₋₂₀ hydrocarbyl, (optionally C₁₋₁₀ alkyl), more preferably X⁴ and X⁵ independently are O, S, NH or —N(C₁₋₆ alkyl)—, most preferably O,
Z represents C₁₋₄ alkylene, more preferably —CHCH₂(CH₃)—, —CH(CH₃)— or —CH₂CH₂—,

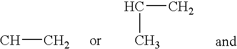

‘w’ represents an integer from 1 to 50, preferably 1 to 30, more preferably 5 to 20.

Particularly preferred non-ionic surfactants are those mixtures of aliphatic non ionic surfactants available from Rhodia under the trade designation Abex 2535.

The surfactant mixture may optionally further comprise another ionic surfactant selected from a polycarboxylic acid and/or ester substituted by at least one electronegative substituent formed from a strong acid, preferably selected from a mono valent oxy substituted sulfo anion, and/or a mono valent oxy substituted phospho anion.

The total amount of surfactant used to make the emulsion of the invention based on the total weight of monomers is about 0.1 to about 5% by weight, preferably from about 0.5 to about 2% by weight.

In a further aspect of the present invention there is provided a process for preparing polymeric latex emulsion suitable for use as a pressure sensitive adhesive, the process comprising the steps of
(a) forming in the presence of an effective amount of a surfactant mixture comprising
   (i) at least one ionic surfactant comprising
      (I) a plurality, preferably at least three, aromatic rings,
      (II) at least one electronegative substituent formed from a strong acid, optionally selected from a mono valent oxy substituted sulfo anion, and/or a mono valent oxy substituted phospho anion, and
      (III) optionally at least one substituent comprising multiple hetero-organo units, optionally one or more repeating oxyhydrocarbylene units which may be the same or different,
   (ii) optionally at least one non-ionic surfactant optionally non aromatic which preferably comprises at least one at least one substituent comprising multiple hetero-organo units, optionally one or more repeating oxyhydrocarbylene units which may be the same or different, and
   (iii) optionally a further ionic surfactant which may be as defined in (a) (i) an aqueous dispersion of:
   at least one hydrophobic polymer precursor(s) (Component I),
   at least one hydrophilic polymer precursor(s) (Component II)
   at least one partially polymer precursor(s) (Component III)
(b) polymerising said polymer precursor(s) simultaneously or subsequent to forming the dispersion in step (a) to form a latex emulsion; and
(c) optionally adjusting the pH of said emulsion with a suitable base to a pH of about 6.5 to about 9;
   wherein said effective amount of surfactant in said mixture is that amount necessary to produce a pressure sensitive adhesive having sufficient stability so substantially no coagulum forms when the latex is subject to a shear field of at least 4000 s⁻¹ for at least 2 minutes.

In an optional embodiment of the process of the present invention, the process comprises the addition steps of
forming further effective amount of the mixture from step (a) with an initial amount of thermal polymerization initiator to form a second mixture;
continuously adding the first dispersion formed from step (a) (the pre-emulsion) to the initiator mixture formed above to polymerize said pre-emulsion to form a latex emulsion, wherein additional polymerization initiator is added during the polymerization of said pre-emulsion.

Preferably an aqueous dispersion of the invention has a total solid content of from about 40% to about 80%, more preferably from about 50% to 70%, most preferably from about 60% to about 70%, for example from about 65% to about 70% by weight of the total dispersion.

Usefully in a process of the invention a PSA of the invention was obtained and/or is obtainable by polymerisation of the monomers in the presence of a water soluble initiator in an amount less than about 3.0%, more usefully less than about 2.0%, most usefully less than about 1.02%, for example from about 0.5% to about 1.0% by weight of the total monomer composition.

In a yet other aspect of the present invention there is provided a method of using a surfactant mixture for the purpose of enhancing water whitening resistance in a high shear stable PSA latex where the surfactant mixture comprising at least two different ionic surfactant comprising a plurality of aromatic groups and at least one electronegative substituent formed from a strong acid, preferably selected from a mono valent oxy substituted sulfo anion, and/or a mono valent oxy substituted phospho anion, (preferably (i) at least one ionic surfactant of Formula 1 and (ii) one ionic surfactant of Formula 2 as defined herein) with optionally at least one non-ionic surfactant.

A still further aspect of the invention provides a dispersion obtained and/or obtainable from a process of the invention as described herein.

A still other aspect of the invention provides a pressure sensible adhesive obtained and/or obtainable from a dispersion of the invention as described herein.

Another aspect of the invention provides an adhesive laminate comprising a substantially transparent facestock having an adhesive coating thereon and optionally a release liner, the coating comprising a pressure sensible adhesive (PSA) of the invention as described herein (or a PSA obtained and/or obtainable from a dispersion of the invention as described herein), where the laminate exhibits acceptable, optionally enhanced resistance to water whitening and acceptable, optionally enhanced, resistance to high shear.

Still yet other aspect of the invention provides an article and/or container labeled with an adhesive laminate of the invention.

A further aspect of the invention provides a method of coating (preferably curtain coating) a substrate with the dispersion of the invention at high speed under high shear (optionally at least 4000 s⁻¹, preferably at least 20,000 s⁻¹, more preferably at least 70,000 s⁻¹, for example at least 150,000 s⁻¹) to obtain a film pressure sensitive adhesive thereon.

### Monomer Composition

Unless otherwise indicated (e.g. for amounts of aryl arylalkylene within Component I) all of the weight amounts described herein for the following monomers are given as weight percentages by the total weight of monomers (Components I, II & III).

### Component I

The hydrophobic monomer (Component I) may comprise, conveniently consist essentially of, at least one hydrophobic polymer precursor comprising at least one activated unsaturated moiety (conveniently at least one hydrophobic (meth)acrylate monomer) and/or arylalkylene polymer precursor.

Preferably the hydrophobic (meth)acrylate comprises C,_{<4} hydrocarbo (meth)acrylate(s) and conveniently the C_{<4} hydrocarbo moiety may be C₄₋₂₀ hydrocarbyl, more conveniently C₄₋₁₄ alkyl most conveniently C₄₋₁₀ alkyl, for example C₄₋₈ alkyl.

Suitable hydrophobic (meth)acrylate(s) are selected from: isooctyl acrylate, 4-methyl-2-pentyl acrylate, 2-methylbutyl acrylate, isoamyl acrylate, sec-butyl acrylate, n-butyl acrylate, 2-ethylhexyl acrylate, isodecyl methacrylate, isononyl acrylate, isodecyl acrylate, and/or mixtures thereof, especially 2-ethylhexyl acrylate and/or butyl acrylate, for example n-butyl acrylate.

Preferably the arylalkylene comprises (optionally hydrocarbo substituted) stryene and conveniently the optional hydrocarbo may be C₁₋₁₀ hydrocarbyl, more conveniently C₁₋₄ alkyl.

Suitable arylalkylene monomers are selected from: styrene, α-methyl styrene, vinyl toluene, t-butyl styrene, di-methyl styrene and/or mixtures thereof, especially styrene.

The arylalkylene monomer may be present in Component I (the total hydrophobic monomer) up to about 30%, preferably from about 1% to about 20%, and more preferably from about 5% to about 15% by total weight of Component I.

The currently preferred Component I is n-butyl acrylate.

Component I may be present in a total amount from about 70% to about 90%, preferably from about 75% to about 85% by weight.

### Component II

Suitable hydrophilic polymer precursors of Component II are those that are co-polymerisible with the hydrophobic polymer precursors(s) of Component I and are water soluble. Conveniently the at least one hydrophobic polymer precursor may comprise at least one activated unsaturated moiety.

Preferred hydrophilic monomers comprise, advantageously consist essentially of, at least one ethylenically unsaturated carboxylic acid. More preferred acids have one ethylenic group and one or two carboxy groups. Most preferably the acid(s) are selected from the group consisting of: acrylic acid (and oligomers thereof), beta carboxy ethyl acrylate, citraconic acid, crotonic acid, fumaric acid, itaconic acid, maleic acid, methacrylic acid and mixtures thereof; for example acrylic acid, methacrylic acid and mixtures thereof.

The currently preferred Component II is acrylic acid.

Component II may be present in a total amount of up to 10%, preferably from about 0.1% to about 5%, more preferably from about 0.1% to about 3%, most preferably from about 0.5% to about 2.5% by weight.

### Component III

The partially hydrophilic polymer precursor(s) of Component III may also be referred to as partially water soluble monomers and conveniently may comprise at least one activated unsaturated moiety.

Preferred partially hydrophilic monomers comprise, conveniently consist essentially of, at least one C₁₋₂ alkyl (meth)acrylate. More preferred partially hydrophilic monomers are selected from the group consisting of: methyl acrylate, methyl methacrylate, ethyl acrylate and mixtures thereof; most preferably ethyl acrylate, methyl methacrylate, and mixtures thereof.

The currently preferred Component III is a mixture of methyl methacrylate and ethyl acrylate.

Component III may be present in a total amount of at least about 5%, preferably from about 5% to about 20%, more preferably from about 5% to about 18%, most preferably from about 10% to about 16% by weight.

### Activated Unsaturated Moiety

The term “activated unsaturated moiety”, is used herein to denote a species comprising at least one unsaturated carbon to carbon double bond in chemical proximity to at least one activating moiety. Preferably the activating moiety comprises any group which activates an ethylenically unsaturated double bond for addition thereon by a suitable electrophillic group. Conveniently the activating moiety comprises oxy, thio, (optionally organo substituted)amino, thiocarbonyl and/or carbonyl groups (the latter two groups optionally substituted by thio, oxy or (optionally organo substituted) amino). More convenient activating moieties are (thio)ether, (thio)ester and/or (thio)amide moiet(ies). Most convenient “activated unsaturated moieties” comprise an “unsaturated ester moiety” which denotes an organo species comprising one or more “hydrocarbylidenyl(thio)carbonyl(thio)oxy” and/or one or more “hydrocarbylidenyl(thio)-carbonyl(organo)amino” groups and/or analogous and/or derived moieties for example moieties comprising (meth)acrylate functionalities and/or derivatives thereof. “Unsaturated ester moieties” may optionally comprise optionally substituted generic α,β-unsaturated acids, esters and/or other derivatives thereof including thio derivatives and analogs thereof.

Preferred activated unsaturated moieties are those represented by a radical of Formula 5.

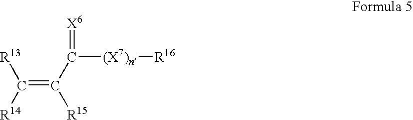

where n′ is 0 or 1, X⁶ is oxy or, thio; X⁷ is oxy, thio or NR¹⁷ (where R¹⁷ represents H or optionally substituted organo), R¹³, R¹⁴, R¹⁵ and R¹⁶ each independently represent a bond to another moiety in Formula 1, H, optional substituent and/or optionally substituted organo groups, where optionally any of R¹³, R¹⁴, R¹⁵ and R¹⁶ may be linked to form a ring; where at least one of R¹³, R¹⁴ R¹⁵ and R¹⁶ is a bond; and all suitable isomers thereof, combinations thereof on the same species and/or mixtures thereof.

The terms “activated unsaturated moiety”; “unsaturated ester moiety” and/or Formula 5 herein represents part of a formula herein and as used herein these terms denote a radical moiety which depending where the moiety is located in the formula may be monovalent or multivalent (e.g. divalent).

More preferred moieties of Formula 5 (including isomers and mixtures thereof) are those where n′ is 1; X⁶ is O; X⁷ is O, S or NR⁷.

R¹³, R¹⁴ R¹⁵ and R¹⁶ are independently selected from: a bond, H, optional substituents and optionally substituted C₁₋₁₀ hydrocarbo, optionally R¹⁵ and R¹⁶ may be linked to form (together with the moieties to which they are attached) a ring; and where present R¹⁷ is selected from H and optionally substituted C₁₋₁₀ hydrocarbo.

Most preferably n′ is 1, X⁶ is O; X⁷ is O or S and R¹³, R¹⁴ R¹⁵ and R¹⁶ are independently a bond, H, hydroxy and/or optionally substituted C₁₋₆ hydrocarbyl.

For example n′ is 1, X⁶ and X⁷ are both O; and R³, R⁴, R⁵ and R⁶ are independently a bond, H, OH, and/or C₁₋₄ alkyl; or optionally R⁵ and R⁶ may together form a divalent C₀₋₄ alkylenecarbonyl C₀₋₄ alkylene moiety so Formula 5 represents a cyclic anhydride (e.g. when R¹⁵ and R¹⁶ together are carbonyl then Formula 5 represents a maleic anhydride or derivative thereof).

For moieties of Formula 5 where n′ is 1 and X⁶ and X⁷ are both O then when one of (R¹³ and R¹⁴) is H and also R¹³ is H, Formula 5 represents an acrylate moiety, which includes acrylates (when both R¹³ and R¹⁴ are H) and derivatives thereof (when either R¹³ and R¹⁴ is not H). Similarly when one of (R¹³ and R¹⁴) is H and also R¹⁵ is CH₃, Formula 5 represents an methacrylate moiety, which includes methacrylates (when both R¹³ and R¹⁴ are H) and derivatives thereof (when either R¹³ and R¹⁴ is not H). Acrylate and/or methacrylate moieties of Formula 5 are particularly preferred.

Conveniently moieties of Formula 5 are those where n′ is 1; X⁶ and X⁷ are both O; R¹³ and R¹⁴ are independently a bond, H, CH₃ or OH, and R¹⁵ is H or CH₃; R¹⁶ is H or R¹⁵ and R¹⁶ together are a divalent C═O group.

More conveniently moieties of Formula 5 are those where n′ is 1; X⁶ and X⁷ are both O; R¹³ is OH, R⁴ is CH₃, and R¹⁵ is H and R⁶ is a bond and/or tautomer(s) thereof (for example of an acetoacetoxy functional species).

Most convenient unsaturated ester moieties are selected from: —OCO—CH═CH₂; —OCO—C(CH₃)═CH₂; acetoacetoxy, —OCOCH═C(CH₃)(OH) and all suitable tautomer(s) thereof.

It will be appreciated that any suitable moieties represented by Formula 5 could be used in the context of this invention such as other reactive moieties.

### General

The terms ‘optional substituent’ and/or ‘optionally substituted’ as used herein (unless followed by a list of other substituents) signifies the one or more of following groups (or substitution by these groups): carboxy, sulpho, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulphonyl if directly attached to each other represent a sulphamoyl group). Preferred optional substituents comprise: carboxy, sulpho, hydroxy, amino, mercapto, cyano, methyl, halo, trihalomethyl and/or methoxy.

The synonymous terms ‘organic substituent’ and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclyl groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group may be selected from: hydrogen, halo, phosphorus, nitrogen, oxygen, silicon and/or sulphur, more preferably from hydrogen, nitrogen, oxygen, phosphorus and/or sulphur. Convenient phosphorous containing groups may comprise: phosphinyl (i.e. a ‘—PR₃’ radical where R independently denotes H or hydrocarbyl); phosphinic acid group(s) (i.e. a ‘—P(═O)(OH)₂’ radical); and phosphonic acid group(s) (i.e. a ‘—P(═O)(OH)₃’ radical).

Most preferred organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulphinyl, sulphonyl, amino, imino, nitrilo and/or combinations thereof. Organic groups include all chemically possible combinations in the same moiety of a plurality (preferably two) of the aforementioned carbon containing and/or heteroatom moieties (e.g. alkoxy and carbonyl if directly attached to each other represent an alkoxycarbonyl group).

The term ‘hydrocarbo group’ as used herein is a sub-set of a organic group and denotes any univalent or multivalent moiety (optionally attached to one or more other moieties) which consists of one or more hydrogen atoms and one or more carbon atoms and may comprise one or more saturated, unsaturated and/or aromatic moieties. Hydrocarbo groups may comprise one or more of the following groups. Hydrocarbyl groups comprise univalent groups formed by removing a hydrogen atom from a hydrocarbon (for example alkyl). Hydrocarbylene groups comprise divalent groups formed by removing two hydrogen atoms from a hydrocarbon, the free valencies of which are not engaged in a double bond (for example alkylene). Hydrocarbylidene groups comprise divalent groups (which may be represented by “R₂C═”) formed by removing two hydrogen atoms from the same carbon atom of a hydrocarbon, the free valencies of which are engaged in a double bond (for example alkylidene). Hydrocarbylidyne groups comprise trivalent groups (which may be represented by “RC≡”), formed by removing three hydrogen atoms from the same carbon atom of a hydrocarbon the free valencies of which are engaged in a triple bond (for example alkylidyne). Hydrocarbo groups may also comprise saturated carbon to carbon single bonds (e.g. in alkyl groups); unsaturated double and/or triple carbon to carbon bonds (e.g. in respectively alkenyl and alkynyl groups); aromatic groups (e.g. in aryl groups) and/or combinations thereof within the same moiety and where indicated may be substituted with other functional groups

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group which comprises a chain of three or more atoms signifies a group in which the chain wholly or in part may be linear, branched and/or form a ring (including spiro and/or fused rings). The total number of certain atoms is specified for certain substituents for example C_{1-N} organo, signifies a organo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable and/or effective.

Preferably any of the organo groups listed herein comprise from 1 to 36 carbon atoms, more preferably from 1 to 18. It is particularly preferred that the number of carbon atoms in an organo group is from 1 to 12, especially from 1 to 10 inclusive, for example from 1 to 4 carbon atoms.

As used herein chemical terms (other than IUAPC names for specifically identified compounds) which comprise features which are given in parentheses—such as (alkyl)acrylate, (meth)acrylate and/or (co)polymer—denote that that part in parentheses is optional as the context dictates, so for example the term (meth)acrylate denotes both methacrylate and acrylate.

Certain moieties, species, groups, repeat units, compounds, oligomers, polymers, materials, mixtures, compositions and/or formulations which comprise and/or are used in some or all of the invention as described herein may exist as one or more different forms such as any of those in the following non exhaustive list: stereoisomers (such as enantiomers (e.g. E and/or Z forms), diastereoisomers and/or geometric isomers); tautomers (e.g. keto and/or enol forms), conformers, salts, zwitterions, complexes (such as chelates, clathrates, crown compounds, cyptands/cryptades, inclusion compounds, intercalation compounds, interstitial compounds, ligand complexes, organometallic complexes, non-stoichiometric complexes, π-adducts, solvates and/or hydrates); isotopically substituted forms, polymeric configurations [such as homo or copolymers, random, graft and/or block polymers, linear and/or branched polymers (e.g. star and/or side branched), cross-linked and/or networked polymers, polymers obtainable from di and/or tri-valent repeat units, dendrimers, polymers of different tacticity (e.g. isotactic, syndiotactic or atactic polymers)]; polymorphs (such as interstitial forms, crystalline forms and/or amorphous forms), different phases, solid solutions; and/or combinations thereof and/or mixtures thereof where possible. The present invention comprises and/or uses all such forms which are effective as defined herein.

Polymers of the present invention may be prepared by one or more suitable polymer precursor(s) which may be organic and/or inorganic and comprise any suitable (co)monomer(s), (co)polymer(s) [including homopolymer(s)] and mixtures thereof which comprise moieties which are capable of forming a bond with the or each polymer precursor(s) to provide chain extension and/or cross-linking with another of the or each polymer precursor(s) via direct bond(s) as indicated herein.

Polymer precursors of the invention may comprise one or more monomer(s), oligomer(s), polymer(s); mixtures thereof and/or combinations thereof which have suitable polymerisible functionality.

A monomer is a substantially monodisperse compound of a low molecular weight (for example less than one thousand daltons) which is capable of being polymerised.

A polymer is a polydisperse mixture of macromolecules of large molecular weight (for example many thousands of daltons) prepared by a polymerisation method, where the macromolecules comprises the multiple repetition of smaller units (which may themselves be monomers, oligomers and/or polymers) and where (unless properties are critically dependent on fine details of the molecular structure) the addition or removal one or a few of the units has a negligible effect on the properties of the macromolecule.

A oligomer is a polydisperse mixture of molecules having an intermediate molecular weight between a monomer and polymer, the molecules comprising a small plurality of monomer units the removal of one or a few of which would significantly vary the properties of the molecule.

Depending on the context the term polymer may or may not encompass oligomer.

The polymer precursor of and/or used in the invention may be prepared by direct synthesis or (if the polymeric precursor is itself polymeric) by polymerisation. If a polymerisible polymer is itself used as a polymer precursor of and/or used in the invention it is preferred that such a polymer precursor has a low polydispersity, more preferably is substantially monodisperse, to minimise the side reactions, number of by-products and/or polydispersity in any polymeric material formed from this polymer precursor. The polymer precursor(s) may be substantially un-reactive at normal temperatures and pressures.

Except where indicated herein polymers and/or polymeric polymer precursors of and/or used in the invention can be (co)polymerised by any suitable means of polymerisation well known to those skilled in the art. Examples of suitable methods comprise: thermal initiation; chemical initiation by adding suitable agents; catalysis; and/or initiation using an optional initiator followed by irradiation, for example with electromagnetic radiation (photo-chemical initiation) at a suitable wavelength such as UV; and/or with other types of radiation such as electron beams, alpha particles, neutrons and/or other particles.

The substituents on the repeating unit of a polymer and/or oligomer may be selected to improve the compatibility of the materials with the polymers and/or resins in which they may be formulated and/or incorporated for the uses described herein. Thus the size and length of the substituents may be selected to optimise the physical entanglement or interlocation with the resin or they may or may not comprise other reactive entities capable of chemically reacting and/or cross-linking with such other resins as appropriate.

### Particle Size

Advantageously PSAs of the invention can be made having a broad particle size distribution. There are process advantages in using a larger particle size (e.g. reduced viscosity) so in a preferred embodiment of the invention the particle size of the PSA is more than 100 nm, conveniently from about 100 nm to about 400 nm, more conveniently from about 200 nm to about 300 nm. The particle sizes herein are number average which may be measured by any suitable method such as light scattering.

### Other Components

In compositions of the invention the surfactant package selected for the polymerization is substantially free of alkyl phenol ethoxylates (APEO) which are undesired for environment reasons. Yet stable operating conditions are still achieved with a stable pre-emulsion and low polymer grits in the final polymer emulsion whilst having a very high final solids content (typically 65-67 wt %).

The final emulsion of the invention is shear stable under a defined range of shear rates. For example when subject to a 150,000 s⁻¹ high shear field (Haake) the latex remains stable. The shear stability can be increased still further by selecting further suitable additives (such as additional surfactants, defoamer and/or rheological modifier) to further control the colloidal stability and rheology of the dispersion.

The process(es) of the invention also utilizes at least one water-soluble polymerization initiator. Any conventional water-soluble polymerization initiator that is normally acceptable for emulsion polymerization of acrylate monomers may be used and such polymerization initiators are well known in the art. The typical concentration of water-soluble polymerization initiators is about 0.01 wt. % to about 1 wt. %, preferably about 0.01 wt. % to about 0.5 wt. %, of the total weight of monomers charged in the pre-emulsion. The water soluble polymerization initiators can be used alone or used in combination with one or more conventional reducing agents, such as bisulfites, metabisulfites, ascorbic acid, sodium formaldehyde sulfoxylate, ferrous sulfate, ferrous ammonium sulfate, ferric ethylenediamine-tetraacetic acid, and the like. Water-soluble polymerization initiators that can be employed according to the invention include water soluble persulfates, peroxides, azo compounds and the like, and mixtures thereof.

Examples of water soluble initiators include, but are not limited to, persulfates (e.g. potassium persulfate, and sodium persulfate), peroxides (e.g. hydrogen peroxide, and tert-butyl hydroperoxide), and azo compounds (e.g. 4,4′-azobis(4-cyano-pentanoic acid), V-501 from Wako Chemicals). Currently the preferred water soluble polymerization initiators are the persulfates, particularly potassium or sodium persulfates.

The amount of water-soluble or water-dispersible surfactant added to the mixture of water, monomers and polymerization initiator is that amount effective to produce a latex emulsion having particles having an average particle size described herein. The effective amount needed to obtain the required particle size will be dependent on operating conditions known in the art to have an affect on particle size, including agitation (shear), viscosity, and the like. The remainder surfactant can be added at the beginning of the polymerisation, to form a pre emulsion, in batches during polymerisation and/or with monomers.

The polymerization can be initiated by any conventional method known to those skilled in the art, such as by application of heat or radiation, though heat is preferred. The method of initiation will be dependent on the water-soluble polymerization initiator used and will be readily apparent to those skilled in the art.

A water soluble polymerization initiator can be added to the polymerization reaction in any conventional manner known in the art. It is currently preferred to add a portion of the initiator to the initial reactor charge which comprises water, an effective amount of the water-soluble or water-dispersible surfactant, and an initial amount of the polymerization initiator. The remainder of the initiator can be added continuously or incrementally during the emulsion polymerization. It is currently preferred to incrementally add the remaining initiator.

Following polymerization, the pH of the latex emulsion may be adjusted by contacting the latex emulsion with a suitable base in an amount necessary to raise the pH to about 5.5 to about 9 (for example if enhanced water whitening resistance in the PSA coating is desired) but this step is optional.

The polymerization reaction can be conducted in any conventional reaction vessel capable of an emulsion polymerization.

The polymerization can be conducted at a temperature typical for emulsion polymerizations. The polymerization is preferably conducted at a temperature in the range of about 50° C. to about 95° C., preferably in the range of about 60° C. to about 85° C.

The polymerization time is that time needed to achieve the desired conversion based on the other reaction conditions, e.g. temperature profile, and reaction components, e.g. monomers, initiator, etc. The polymerization time will be readily apparent to those skilled in the art.

Many other variations embodiments of the invention will be apparent to those skilled in the art and such variations are contemplated within the broad scope of the present invention.

Unless the context clearly indicates otherwise, as used herein plural forms of the terms herein are to be construed as including the singular form and vice versa.

The term “comprising” as used herein will be understood to mean that the list following is non-exhaustive and may or may not include any other additional suitable items, for example one or more further feature(s), component(s), ingredient(s) and/or substituent(s) as appropriate.

The terms ‘effective’, ‘acceptable’ ‘active’ and/or ‘suitable’ (for example with reference to any process, use, method, application, preparation, product, material, formulation, compound, monomer, oligomer, polymer precursor, and/or polymers of the present invention and/or described herein as appropriate) will be understood to refer to those features of the invention which if used in the correct manner provide the required properties to that which they are added and/or incorporated to be of utility as described herein. Such utility may be direct for example where a material has the required properties for the aforementioned uses and/or indirect for example where a material has use as a synthetic intermediate and/or diagnostic tool in preparing other materials of direct utility. As used herein these terms also denote that a functional group is compatible with producing effective, acceptable, active and/or suitable end products.

Preferred utility of the present invention comprises use as a pressure sensitive adhesive, preferably having enhanced water whitening resistance and sufficient stability in a high shear field to be curtain coatable.

Further aspects of the invention and preferred features thereof are given in the claims herein.

### EXAMPLE

The present invention will now be described in detail with reference to the following non limiting examples which are by way of illustration only.

### ABBREVIATIONS OF MATERIALS

AA acrylic acid
Abex 2535 an aliphatic ethoxylate nonionic surfactant
Acticide MBS a biocide containing 1,2-benzisothiazolin-3-one and 2-methyl-4-isothiazolin-3-one.
AOT sodium dioctylsulfosuccinate from Cytec under the trade designation Aerosol OT
BA butyl acrylate
DI water de-ionised water
DPOS-45 a mixture of disodium mono and didodecyl diphenyl oxide disulfonate from Cytec under the trade designation Aerosol DPOS-45
EA: ethyl acrylate.
Luperox H70 70% aqueous dispersion of tetra-butyl hydrogen peroxide (TBHP)
MMA methyl methacrylate
NaPS sodium persulfate
Rongalit C 5% aqueous dispersion of sodium formaldehyde sulfoxylate
Soprophor 4D384 sulfated polyarylphenol ethoylate, ammonium salt

### Example 1

| | Amount (g) | | Wt % on monomer | |
|---|---|---|---|---|
| Material | Reactor | Pre-emulsion | Total | Active |
| DI water | 356.7.0 | | 29.725 | 0.000 |
| NaPS | 8.890 | | 0.741 | 0.741 |
| DI water | 30 | | 2.5 | 0.000 |
| NaHCO₃ | 3.253 | | 0.271 | 0.271 |
| DI water | | 160 | 13.333 | 0.000 |
| Soprophor | | 49.657 | 4.138 | 1.035 |
| 4D384/25% | | | | |
| Abex 2535 | | 11.926 | 0.994 | 0.497 |
| DPOS-45 | | 4.337 | 0.361 | 0.163 |
| AA | | 12.360 | 1.030 | 1.030 |
| MMA | | 168.919 | 14.077 | 14.077 |
| EA | | 21.684 | 1.807 | 1.807 |
| BA | | 997.037 | 83.086 | 83.086 |
| Luperox H | 24.784 | | 2.065 | 0.145 |
| 70/6.36% | | | | |
| Rongalit C/5% | 21.684 | | 1.807 | 0.090 |
| Ammonia/25% | 2.18 | | 0.182 | 0.046 |
| Acticide MBS | 2.602 | | 0.217 | 0.022 |

In a jacketed reactor equipped with a reflux condenser, thermocouple and twin blade agitator, a PSA latex was prepared.

The composition of this example polymer is acrylic acid/methyl methacrylate/ethyl acrylate/butyl acrylate. In the process, part of the de-ionised water, surfactants and the monomers are mixed to form a moderately thin, white pre-emulsion in a separate delay tank. The polykettle is charged with the rest of the de-ionised water. A 5% solution of sodium persulfate is prepared in a second delay vessel. The jacket of the polykettle is heated until the polykettle mixture reaches 82° C., at which point part of the initiator solution is charged over 5 minutes. Immediately, the pre emulsion delay and the initiator delay are started. The pre emulsion delay period is 200 minutes and the initiator delay period is 210 minutes. The reaction temperature is maintained at 83° C. during the delays. At the end of the initiator delay, the reactor content is held for 60 minutes at 86° C. After the hold period, the reaction temperature is cooled to 57° C. and the post-polymerization redox initiator system is added. The batch is held at 55° C. for 20 minutes and cooled to 45° C. The total solids is 67%.

The latex was sufficiently stable under high shear to be coatable onto a label facestock using a curtain coater.

1. An aqueous dispersion suitable for preparing pressure sensitive adhesive (PSA) having acceptable, optionally enhanced, resistance to water-whitening and acceptable, optionally enhanced, stability under high shear, where the dispersion comprises:
(a) an effective amount of surfactant mixture comprising
(i) at least one ionic surfactant comprising
(I) a plurality, preferably at least three, aromatic rings,
(II) at least one electronegative substituent formed from a strong acid, optionally selected from a mono valent oxy substituted sulfo anion, and/or a mono valent oxy substituted phospho anion, and
(III) optionally at least one substituent comprising multiple hetero-organo units, optionally one or more repeating oxyhydrocarbylene units which may be the same or different,
(ii) optionally at least one non-ionic surfactant optionally non aromatic which preferably comprises at least one at least one substituent comprising multiple hetero-organo units, optionally one or more repeating oxyhydrocarbylene units which may be the same or different, and
(iii) optionally a further ionic surfactant which may be as defined in (a) (i)
(b) a monomer composition comprising:
(i) at least one hydrophobic monomer (Component I),
(ii) at least one hydrophilic monomer (Component II)
(iii) at least one partially hydrophilic monomer (Component III).

2. A pressure sensitive adhesive (PSA) obtainable from a dispersion as claimed in claim 1, where the adhesive forms substantially no coagulum when the dispersion is subject to a shear field of at least 4000 s⁻¹ for at least 2 minutes.

3. A dispersion or PSA as claimed in claim 1 where at least one of the aromatic ionic surfactants is represented by Formula 1 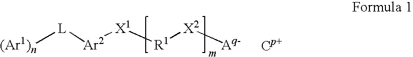
where Ar¹ and Ar² independently in each case each represent C₆₋₁₈ hydrocarbo comprising an aromatic moiety,
L is a divalent organo linking group or direct bond, where optionally Ar¹ and Ar² may together form a fused ring;
R¹ is an optionally substituted C₁₋₈ hydrocarbylene;
X¹ and X² independently in each case each represent O, S, CH₂, NH or NR³ where R3 represents optionally substituted C₁₋₂₀ hydrocarbyl;
A represents a S(O)₁₋₃ or P(O)₁₋₃ moiety and q is from 1 to 3;
C is a suitable counter cation and p balances the charge q;
m represents an integer from 1 to 50; and
n represents an integer 1 to 6.

4. A dispersion or PSA as claimed in claim 3 where Formula 1 is represented by Formula 1a 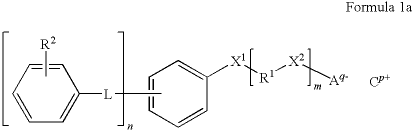
where L, R¹, X¹, X², A, C, q, p, n and m are as given for Formula 1, and R² is an optionally substituted C₁₋₈ hydrocarbylene.

5. A dispersion or PSA as claimed in claim 4 where in Formula 1a
L, R² and R² are independently in each case C₁₋₄ alkylene,
X¹ and X² independently in each case O, S, NH or —N(C₁₋₆ alkyl)—,
A is a S(O)₃ or P(O)₃ and q is 1
C is a suitable counter cation and optionally p is 1;
n is from 1 to 3; and m is from 10 to 30.

6. A dispersion or PSA as claimed in claim 1 where at least one of the aromatic ionic surfactants is

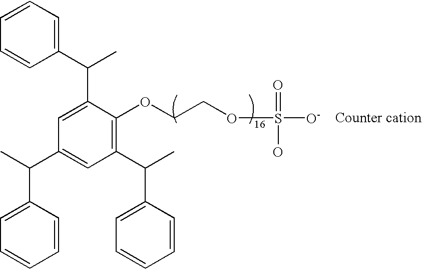

7. A dispersion or PSA as claimed in claim 3, where at least one of the aromatic ionic surfactants is represented by Formula 2 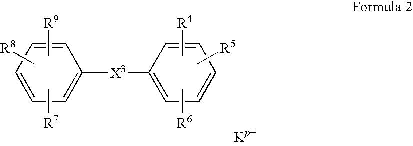
in which
X³ represents O, S, CH₂, NH or NR¹⁰ where R¹⁰ represents optionally substituted C₁₋₂₀ hydrocarbyl,
from 1 to 4 (preferably 1 to 2) of the radicals R⁴ to R⁹ are at least one electronegative substituent formed from a hard acid, preferably selected from a mono valent oxy substituted sulfo anion, and/or a mono valent oxy substituted phospho anion;
and the remainder of R⁴ to R⁹ are independently H or C₁₋₃₀ hydrocarbyl; and
K^{p+} is a counter cation where ‘P’ is ‘Q’.

8. A dispersion or PSA as claimed in claim 3, where at least one of the aromatic ionic surfactants is selected from 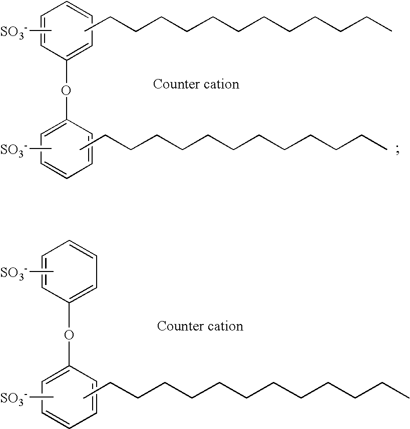
and/or mixtures thereof.

9. A dispersion or PSA as claimed in claim 1 where the non-ionic surfactant is represented by Formula 3
R¹¹—X⁴—(Z—X⁵)_{w}H Formula 3
where
R¹¹ represents optionally substituted C₁₋₅₀ hydrocarbyl;
X⁴ and X⁵ independently in each case each represent O, S, CH₂, NH or NR¹² where R¹² represents optionally substituted C₁₋₂₀ hydrocarbyl,
Z represents C₁₋₄ alkylene, and
‘w’ represents an integer from 1 to 50.

10. A process for preparing polymeric latex emulsion suitable for use as a pressure sensitive adhesive, the process comprising the steps of
(a) forming in the presence of an effective amount of a surfactant mixture comprising
(i) at least one ionic surfactant comprising
(I) a plurality, preferably at least three, aromatic rings,
(II) at least one electronegative substituent formed from a strong acid, optionally selected from a mono valent oxy substituted sulfo anion, and/or a mono valent oxy substituted phospho anion, and
(III) optionally at least one substituent comprising multiple hetero-organo units, optionally one or more repeating oxyhydrocarbylene units which may be the same or different,
(ii) optionally at least one non-ionic surfactant optionally non aromatic which preferably comprises at least one at least one substituent comprising multiple hetero-organo units, optionally one or more repeating oxyhydrocarbylene units which may be the same or different, and
(iii) optionally a further ionic surfactant which may be as defined in (a) (i) an aqueous dispersion of:
at least one hydrophobic polymer precursor(s) (Component I),
at least one hydrophilic polymer precursor(s) (Component II)
at least one partially polymer precursor(s) (Component III)
(b) polymerising said polymer precursor(s) simultaneously or subsequent to forming the dispersion in step (a) to form a latex emulsion;
wherein said effective amount of surfactant in said mixture is that amount necessary to produce a pressure sensitive adhesive having sufficient stability so substantially no coagulum forms when the latex is subject to a shear field of at least 4000 s⁻¹ for at least 2 minutes.
